(19) United States
(12) Patent Application Publication
(10) Pub. No.: US 2003/0089863 A1
(43) Pub. Date: May 15, 2003

(54) Beam-calibration methods for charged-particle-beam microlithography systems

(75) Inventor: Noriyuki Hirayanagi, Tokyo (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 10/264,072

(22) Filed: Oct. 2, 2002

(30) Foreign Application Priority Data
Oct. 2, 2001 (JP) 2001-306671

(51) Int. Cl. G21G 5/00

(52) U.S. Cl. 250/492.2

(57) ABSTRACT

Beam-calibration methods are disclosed for a charged-particle-beam (CPB) microlithography system that can be performed in substantially less time than conventional beam-calibration methods. To calibrate a beam, the reticle stage and substrate stage are moved to position the deflection center of the CPB optical system at the center of a group of calibration subfields each containing calibration mark(s). The beam is deflected laterally so as to scan a first row of calibration subfields while measuring beam characteristics at each subfield. Next, the reticle stage and substrate stage are moved to place the deflection center of the CPB optical system at the center of the subfield group. The beam is deflected laterally so as to scan a second row of calibration subfields while measuring beam characteristics at each subfield. Based on the measurements, a respective optical-system-correction coefficient is established for each calibration subfield. Based on the coefficients, the CPB optical system is calibrated (to reduce, for example, deflection-position error, image-magnification error, and image-rotation error).

### FIELD

This disclosure pertains to microlithography performed using a charged particle beam such as an electron beam or ion beam. Microlithography is a key technology used in the fabrication of microelectronic devices such as semiconductor integrated circuits, displays, and the like. More specifically, this disclosure pertains to methods for calibrating the charged-particle-beam (CPB) optical system in a CPB microlithography system configured to transfer-expose a lithographic pattern defined on a reticle divided into multiple subfields.

### BACKGROUND

In recent years, as the linewidth of circuit elements in microelectronic devices has continued to decrease, the pattern-resolution limitations of optical microlithography have become increasingly difficult to accommodate. As a result, large research and development efforts are underway to develop a practical “next generation” lithography (NGL) technology. One NGL approach is microlithography performed using a charged particle beam such as an electron beam or ion beam.

Part of the development of a practical charged-particle-beam (CPB) microlithography system has been directed to obtaining a suitably high throughput without compromising the resolution of the pattern as transferred to the lithographic substrate. Much earlier work in CPB microlithography was directed to one-shot full-reticle exposure methods, similar to the manner of exposing a full reticle in optical microlithography, in which a full die or even multiple dies are exposed in a single exposure “shot.” Unfortunately, this technique has defied practical application because of the impossibility of fabricating a single-shot reticle and of fabricating CPB lenses capable of projecting large-field images without producing unacceptably high off-axis aberrations.

Hence, the currently most promising approach to achieving the twin goals of high resolution and high throughput is “divided-reticle” microlithography in which the pattern as defined on the reticle is divided into multiple regions, termed “subfields,” that define respective portions of the pattern. The subfields are exposed individually, and the respective images of the subfields are formed on the lithographic substrate such that the images are “stitched” together to form the complete transferred pattern. In this exposure scheme, termed a “scan-and-repeat” scheme, the reticle (mounted on a reticle stage) and substrate (mounted on a substrate stage) are moved continuously while deflecting the charged particle beam laterally in a sequential-step manner to expose the subfields in successive rows in a raster manner. Lateral deflection of the beam in this manner imparts different distortions to the beam by the CPB optical system of the microlithography system, depending upon the angle of deflection relative to the optical axis. Hence, it is necessary to calibrate the CPB optical system at each deflection position. The calibrations yield calibration-coefficient data for the respective positions. These calibration-coefficient data can be used to make respective corrections to the beam as required for reducing the distortion.

Reference is made to FIG. 10(A), which depicts certain aspects of a conventional CPB microlithography system. The upper portion of FIG. 10(A) shows a reticle 110 mounted on a reticle stage 111. The reticle stage 111 is movable at least in the X and Y directions. The position of the reticle stage 111 is determined using a position detector 112 employing a laser interferometer. These determinations are performed in real time.

A calibration mark 110a, used for calibrating the CPB optical system, is defined on the reticle 110. The mark 110a can be, for example, similar to the deflection-measurement mark 120 shown in FIG. 11(A), comprising a subfield containing a longitudinal line-and-space (L/S) pattern 120a situated in the center of the subfield. Alternatively or in addition, the mark 110a can be similar to the imaging-detection mark 121 shown in FIG. 11(B) used for determining rotation, magnification, distortion, etc., of the subfield image. The mark 121 in FIG. 11(B) is configured as a subfield containing multiple mark portions 121a (nine are shown) each including a L/S pattern extending in each of the X and Y directions.

Returning to FIG. 10(A), the CPB microlithography system includes projection lenses 115, 119 and a deflector 116 situated downstream of the reticle 110. A backscattered-particle (e.g., a backscattered-electron or “BSE” detector, which is the term used herein) is situated directly upstream of the substrate 123. The BSE detector 122 detects charged particles backscattered from the exposed surface of the substrate 123 and from mark(s) on the substrate stage 124. The substrate stage 124 is movable in the X and Y directions, and the substrate 123 is mounted to the substrate stage 124 via an electrostatic chuck (not shown). The position of the substrate stage 124 is determined using a position detector 125, comprising a laser interferometer, similar to the position detector 112 associated with the reticle stage 111.

A calibration mark 124a is defined on the substrate 123, or on the substrate stage 124 adjacent the substrate 123, and is used for calibrating the CPB optical system. The mark 124a corresponds to the mark 110a on the reticle 110. A charged particle beam (e.g., electron beam EB), after having been transmitted through the mark 110a, is scanned over the mark 124a. The BSE detector 122 detects backscattered electrons produced by such scanning of the mark 124a. Thus, characteristics of the beam EB are measured. As the two stages 111, 124 move for exposing each successive subfield, the respective deflection positions of the marks 110a, 124a correspondingly move. A respective optical-system calibration coefficient at each deflection position can be established based on measurements obtained from the respective marks at each deflection position.

In the CPB optical system summarized above, a fixed deflection cycle is used during calibration of the CPB optical system in order to stabilize each part of the optical system from a thermal standpoint. Hence, during each calibration the reticle stage 111 and substrate stage 124 are moved to predetermined respective positions, and the marks are detected when the deflection positions of the CPB optical system agree for the marks 110a, 124a. When performing this calibration routine, the time required for moving the stages 111, 124 to position the marks is much longer than the time required for deflecting the beam. I.e., of the time expended in calibrating the CPB optical system, a large amount is expended simply in moving the stages. Thus, calibration time consumes a large proportion of the down-time of the CPB microlithography system, and thus substantially reduces system throughput.

Another conventional scheme for measuring beam characteristics is described with reference to FIG. 10(B), in which two rows of calibration subfields 161-1 to 161-40 are shown. The time required for measuring image characteristics at each of these calibration subfields is greater than the step-scan time consumed in exposing a pattern subfield in a row. As a result, all the calibration subfields cannot be measured in a single mechanical scanning of the reticle and substrate stages. For example, consider a measurement time that is 4×longer than the step-scan time from subfield-to-subfield in an actual pattern-exposure sequence. In a first measurement cycle, the order of calibration subfields that are measured is: 161-1, 161-5, 161-9, 161-13, 161-17, 161-21, 161-25, 161-29, 161-33, 161-37. In a second measurement cycle, the order of calibration subfields that are measured is: 161-2, 161-6, 161-10, 161-14, 161-18, 161-22, 161-26, 161-30, 161-34, 161-38. In this scheme, the stages are moved back and forth many times in order to obtain measurements at each of the calibration subfields. These many stage motions and the cumulative time required for obtaining measurements at each of the calibration subfields results in a substantial adverse effect on throughput.

### SUMMARY

In view of the shortcomings of conventional methods as summarized above, the present invention provides, inter alia, calibration methods for charged-particle-beam (CPB) optical systems, wherein the calibration methods can be performed in substantially less time than conventional calibration methods.

A first aspect of the invention is set forth in the context of a CPB microlithography method in which a pattern, defined on a reticle segmented into multiple pattern subfields and situated on a reticle stage at a reticle plane, is illuminated subfield-by-subfield by a charged-particle illumination beam passing through an illumination-optical system. From such illumination a patterned beam is formed that passes through a projection-optical system to a lithographic substrate situated on a substrate stage at a substrate plane. The projection-optical system forms respective subfield images on the substrate in respective locations at which the images are stitched together to form a transferred pattern. The pattern subfields are arranged on the reticle in a rectilinear array extending in X and Y directions and forming at least one mechanical stripe comprising multiple electrical stripes each consisting of a row of multiple respective pattern. In this context, the subject methods are directed to calibrating the illumination-optical system and the projection-optical system. According to an embodiment of such a method, on each of the reticle plane and substrate plane a respective calibration target is provided each comprising multiple mark-containing calibration subfields arranged in an array corresponding to respective deflection positions of a respective deflection-path cycle assumed by the illumination and patterned beams during sequential exposure of pattern subfields in multiple electrical stripes. While keeping the stages stationary, the illumination and patterned beams are scanned in the X direction and deflected in the Y direction using respective deflectors so as to cause the beams to scan, in a continuously executed, sequential-step manner, an image of the respective calibration subfield at the reticle plane over each respective calibration subfield at the substrate plane. As each calibration subfield at the substrate plane is being scanned, backscattered charged particles produced by impingement of the image of the respective calibration subfield at the reticle plane are detected so as to obtain data regarding beam characteristics at each calibration subfield. From the beam-characteristics data obtained for each calibration subfield, respective CPB-optical-system correction coefficients are determined for each deflection position represented by a respective calibration subfield.

The respective calibration subfields situated at the reticle plane and substrate plane can be on the reticle and lithographic substrate, respectively. Alternatively, the respective calibration subfields can be on the reticle stage and substrate stage, respectively. More generally, the respective calibration subfields situated at the reticle plane can be on the reticle or reticle stage, and the respective calibration subfields situated at the substrate plane can be on the substrate or substrate stage.

For each pattern subfield corresponding to a respective deflection position of the calibration target, at least one of the illumination-optical system and the projection-optical system can be adjusted based on the respective CPB-optical-system correction coefficient for the deflection position.

The step of providing respective calibration targets can comprise providing multiple calibration targets at each of the reticle plane and substrate plane. Each calibration target desirably comprises a respective array of multiple calibration subfields, wherein each array can corresponds to a respective different deflection-path cycle. Alternatively, each array can correspond to a respective different beam characteristic.

Each calibration subfield can comprise at least one calibration mark configured for determining at least one of image rotation, image magnification, and image distortion in the respective deflection position. Alternatively, each calibration subfield can comprise at least one calibration mark configured for determining beam position in the respective deflection position.

Another aspect of the invention is directed to methods for performing CPB microlithography of a pattern, defined on a reticle segmented into multiple pattern subfields arranged in a rectilinear array extending in the X and Y directions and forming at least one mechanical stripe comprising multiple electrical stripes each consisting of a row of multiple respective pattern subfields, to a lithographic substrate. In an embodiment of such a method the reticle is mounted on a reticle stage situated at a reticle plane, and the lithographic substrate is mounted on a substrate stage situated at a substrate plane. The pattern subfields are illuminated in a continuously executed, sequential-step manner with an illumination beam passing through an illumination-optical system, thereby forming a patterned beam. From each illuminated pattern subfield, the patterned beam is directed through a projection-optical system to form a respective subfield image on the substrate in a respective location such that the images are stitched together to form a transferred pattern. On each of the reticle plane and substrate plane, a respective calibration target is provided, each comprising multiple mark-containing calibration subfields arranged in an array in which respective positions of the calibration subfields correspond to respective deflection positions of a deflection-path cycle assumed by the illumination and patterned beams during sequential exposure of the pattern subfields in multiple electrical stripes. While keeping the stages stationary, the illumination and patterned beams are scanned in the X direction and deflected in the Y direction using respective deflectors so as to cause the beams to scan, in a continuously executed, sequential-step manner, an image of the respective calibration subfield at the reticle plane over each respective calibration subfield at the substrate plane. As each calibration subfield at the substrate plane is being scanned, backscattered charged particles produced by impingement of the image of the respective calibration subfield at the reticle plane are detected so as to obtain data regarding beam characteristics at each calibration subfield. From the beam-characteristics data obtained for each calibration subfield, respective CPB-optical-system correction coefficients are determined for each deflection position represented by a respective calibration subfield. As each patterned subfield is being exposed, the beam is corrected according to the respective correction coefficient for the respective deflection position of the patterned subfield being exposed.

According to another aspect of the invention, CPB systems are provided for transferring a pattern, defined on a reticle segmented into multiple pattern subfields each defining a respective portion of the pattern, to a lithographic substrate on which respective images of the pattern subfields are formed so as to be stitched together in a contiguous manner. The pattern subfields are arranged on the reticle in a rectilinear array extending in X and Y directions and forming at least one mechanical stripe comprising multiple electrical stripes each consisting of a row of multiple respective pattern subfields. An embodiment of such a CPB system comprises a reticle stage to which the reticle is mounted at a reticle plane and an illumination-optical system situated upstream of the reticle stage. The illumination-optical system is configured: (1) to direct a charged-particle illumination beam from a source to individual pattern subfields of the reticle, and (2) to cause the illumination beam to be scanned in the X direction and deflected in the Y direction so as to illuminate the pattern subfields in a continuously executed, sequential-step manner. The CPB system also comprises a substrate stage to which the substrate is mounted at a substrate plane, and a projection-optical system situated between the reticle stage and substrate stage. The projection-optical system is configured: (1) to direct a charged-particle patterned beam, produced by passage of the illumination beam through an illuminated pattern subfield, from the reticle to a corresponding selected location on the substrate, and (2) to cause the patterned beam to project respective images of the illuminated pattern subfields sequentially to the substrate. The CPB system also comprises a first beam-calibration target situated at the reticle plane and a corresponding second beam-calibration target situated at the substrate plane. Each beam-calibration target comprises multiple calibration subfields arranged in an array corresponding to respective deflection positions of a deflection-path cycle assumed by the illumination and patterned beams during exposure of the pattern subfields in multiple electrical stripes.

The calibration subfields situated in the first beam-calibration target and the calibration subfields situated in the second beam-calibration target can be situated on the reticle and lithographic substrate, respectively. Alternatively, the calibration subfields can be situated on the reticle stage and substrate stage, respectively. More generally, the respective calibration subfields situated at the reticle plane can be situated on the reticle or reticle stage, and the respective calibration subfields situated at the substrate plane can be situated on the substrate or substrate stage.

The system further can comprise a backscattered-particle detector situated and configured to detect charged particles produced by a calibration subfield in the second beam-calibration target whenever the calibration subfield is being scanned with an image of a corresponding calibration subfield in the first beam-calibration target. Such a system further can comprise a controller connected to the backscattered-particle detector and to each of the illumination-optical system and projection-optical system. The controller desirably is configured to determine a respective beam characteristic as measured at each calibration subfield of the second calibration target. The controller further can be configured to determine, for each beam characteristic, a respective correction coefficient. The controller further can be configured to adjust, for each pattern subfield at a respective deflection position, at least one of the illumination-optical system and projection-optical system as required based on the respective correction coefficient for the deflection position.

If the reticle plane includes multiple first beam-calibration targets, and the substrate plane includes multiple second beam-calibration targets, then each beam-calibration target can comprise a respective array of multiple calibration subfields each corresponding to a respective different deflection-path cycle. Alternatively, each beam-calibration target can comprise a respective array of multiple calibration subfields each corresponding to a respective different beam characteristic.

The first beam-calibration targets can be defined on a first mark plate situated at the reticle plane, and the second beam-calibration targets can be defined on a second mark plate situated at the substrate plane. The first mark plate can be mounted to the reticle stage, and the second mark plate can be mounted to the substrate stage.

Each calibration subfield can comprise at least one calibration mark configured for determining at least one of image rotation, image magnification, and image distortion in the respective deflection position. Alternatively, each calibration subfield can comprise at least one calibration mark configured for determining beam position in the respective deflection position.

The foregoing and additional features and advantages of the invention will be more readily apparent from the following detailed description, which proceeds with reference to the accompanying drawings.

### BRIEF DESCRIPTION OF THE DRAWINGS

FIGS. 1(A)-1(B) depict a calibration target according to a first representative embodiment, and depict deflection positions of the beam at each of respective twenty subfields in each of two exemplary electrical stripes. FIG. 1(A) shows the deflection configuration of the beam, and FIG. 1(B) shows the disposition of subfields that include respective calibration marks.

FIGS. 2(A)-2(B) depict a calibration target according to a second representative embodiment, and depict deflection positions of the beam at each of respective eleven subfields in each of two exemplary electrical stripes. FIG. 2(A) shows the deflection configuration of the beam, and FIG. 2(B) shows the disposition of subfields that include respective calibration marks.

FIGS. 3(A)-3(C) depict respective examples of calibration-mark patterns. FIG. 3(A) depicts an exemplary pattern for measuring image rotation, magnification, distortion, etc., of subfields. FIG. 3(B) depicts an exemplary pattern for measuring deflection position, and FIG. 3(C) depicts an exemplary pattern in which each X-direction subfield is identical.

FIG. 4 depicts other examples of mark groups, specifically a mark group similar to that shown in FIG. 1(B), a mark group similar to that shown in FIG. 3(A), and a mark group similar to that shown in FIG. 3(B)).

FIG. 5 is a schematic elevational diagram showing imaging and control relationships of a charged-particle-beam (CPB) microlithography system utilizing a divided reticle and scan-and-scan exposure of individual subfields of the reticle.

FIGS. 6(A)-6(C) depict a divided reticle as used for step-and-repeat CPB microlithography, wherein FIG. 6(A) is a plan view of the reticle, FIG. 6(B) is an oblique elevational view of a portion of the reticle, and FIG. 6(C) is a plan view of a single subfield of the reticle.

FIG. 7 is an oblique view schematically illustrating certain aspects of transferring a pattern subfield-by-subfield from a reticle to a lithographic substrate.

FIGS. 8(A)-8(B) are respective plan views depicting the manner of making an exposure while deflecting the patterned beam and moving the substrate stage. FIG. 8(A) depicts an exemplary subfield-exposure sequence as viewed from a system fixed to the substrate, and FIG. 8(B) shows the manner in which the patterned beam is deflected to make the successive subfield exposures.

FIGS. 9(A)-9(B) are respective plan views depicting the manner of making an exposure while deflecting the illumination beam and moving the reticle stage. FIG. 9(A) depicts an exemplary subfield-exposure sequence as viewed from a system fixed to the reticle, and FIG. 9(B) shows the manner in which the illumination beam is deflected to make the successive subfield exposures.

FIG. 10(A) is a schematic elevational diagram showing certain aspects of a conventional CPB microlithography system and a conventional method of calibrating the system.

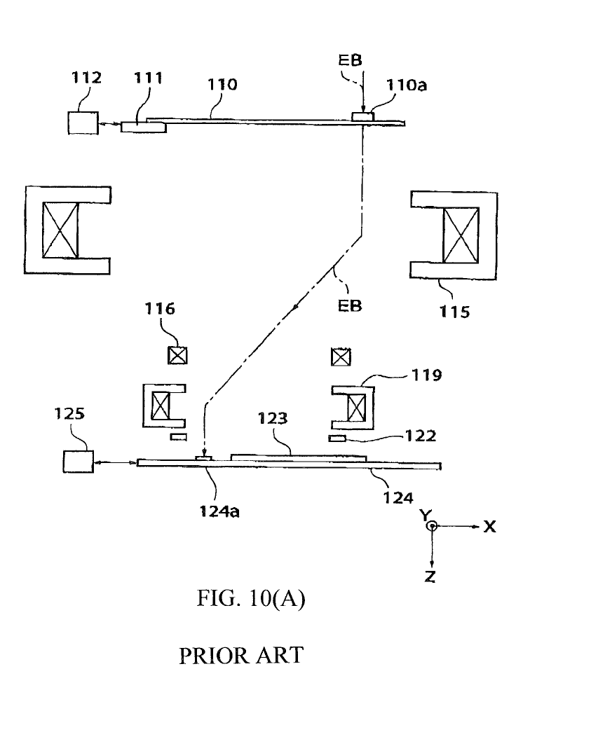

FIG. 10(B) depicts two rows of calibration subfields that are measured according to a conventional method involving many motions of the reticle and substrate stages.

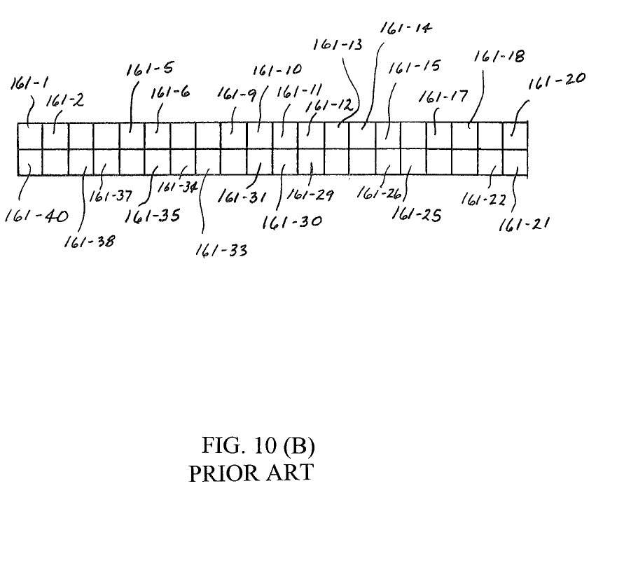

FIGS. 11(A)-11(B) are respective plan views of conventional beam-calibration targets as defined on the reticle, wherein FIG. 11(A) shows a mark for measuring beam-deflection position, and FIG. 11(B) shows a mark for measuring a the rotation, magnification, distortion, etc., of a region exposed in a respective “shot.”

### DETAILED DESCRIPTION

The invention is described below in the context of representative embodiments that are not intended to be limiting in any way. Also, the embodiments are described in the context of using an electron beam as an exemplary charged particle beam. The principles are applicable with equal facility to use of an alternative charged particle beam such as an ion beam.

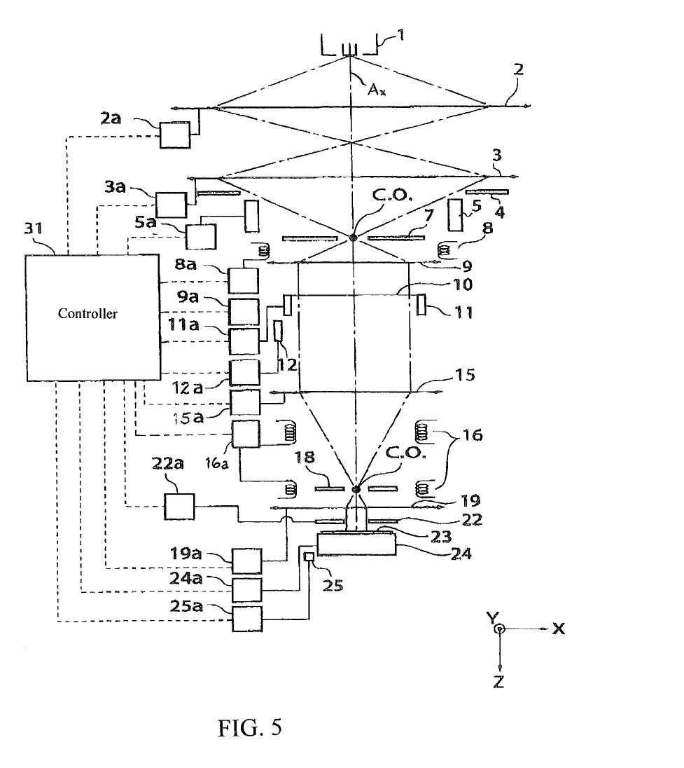

First, an overview of a charged-particle-beam (CPB) microlithography system utilizing a divided reticle is set forth, referring to FIG. 5, which depicts an overview of imaging and control relationships of the CPB optical system. The depicted system can be a “scan-and-repeat” type system.

Situated at the extreme upstream end of the system is an electron gun 1 that emits an electron beam propagating in a downstream direction generally along an optical axis Ax. Downstream of the electron gun 1 are a first condenser lens 2 and a second condenser lens 3 collectively constituting a two-stage condenser-lens assembly. The condenser lenses 2, 3 converge the electron beam at a crossover C.O. situated on the optical axis Ax at a blanking diaphragm 7.

Downstream of the second condenser lens 3 is a “beam-shaping diaphragm” 4 comprising a plate defining an axial aperture (typically rectangular in profile) that trims and shapes the electron beam passing through the aperture. The aperture is sized and configured to trim the electron beam sufficiently to illuminate one subfield on the reticle 10. An image of the beam-shaping diaphragm 4 is formed on the reticle 10 by an illumination lens 9.

The electron-optical components situated between the electron gun 1 and the reticle 10 collectively constitute an “illumination-optical system” of the depicted microlithography system. The electron beam propagating through the illumination-optical system is termed an “illumination beam” because it illuminates a desired region (subfield) of the reticle 10. As the illumination beam propagates through the illumination-optical system, the beam actually travels in a downstream direction through an axially aligned “beam tube” (not shown but well understood in the art) that can be evacuated to a desired vacuum level.

A blanking deflector 5 is situated downstream of the beam-shaping aperture 4. The blanking deflector 5 laterally deflects the illumination beam as required to cause the illumination beam to strike the aperture plate of the blanking diaphragm 7, thereby preventing the illumination beam from being incident on the reticle 10.

A subfield-selection deflector 8 is situated downstream of the blanking diaphragm 7. The subfield-selection deflector 8 laterally deflects the illumination beam as required to illuminate a desired subfield situated on the reticle within the optical field of the illumination optical system. Thus, subfields of the reticle 10 are scanned in a sequential-step manner by the illumination beam in a horizontal direction (X direction in the figure). The illumination lens 9, which forms the image of the beam-shaping diaphragm 4 on the reticle 10, is situated downstream of the subfield-selection deflector 8.

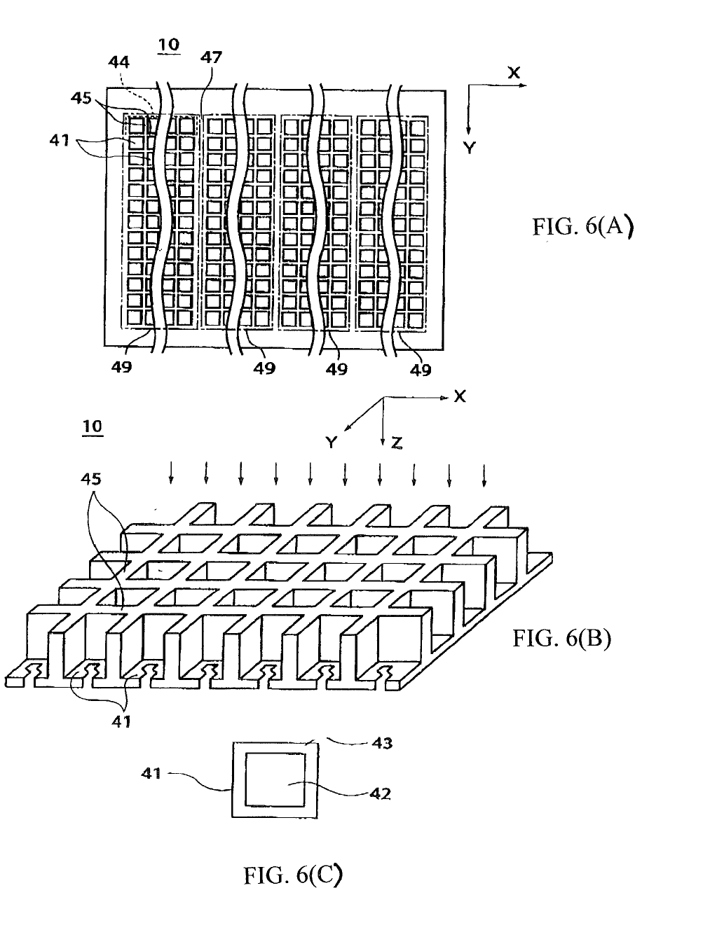

The reticle 10 typically defines many subfields (e.g., tens of thousands of subfields) arrayed in the X-Y reticle plane (see discussion later below in connection with FIG. 6). The subfields collectively define the pattern for a layer to be formed at a single die (“chip”) on a lithographic substrate. It also is possible to divide the pattern for a die into respective portions (e.g., complementary portions) defined on separate reticles. The reticle 10 is mounted on a movable reticle stage 11. Using the reticle stage 11, by moving the reticle 10 in a direction (Y and/or X direction) perpendicular to the optical axis Ax, it is possible to illuminate the respective subfields on the reticle 10 extending over a range that is wider than the optical field of the illumination-optical system. The position of the reticle stage 11 in the XY plane is determined using a “position detector” 12 that typically is configured as a laser interferometer. The laser interferometer is capable of measuring the position of the reticle stage 11 with extremely high accuracy in real time.

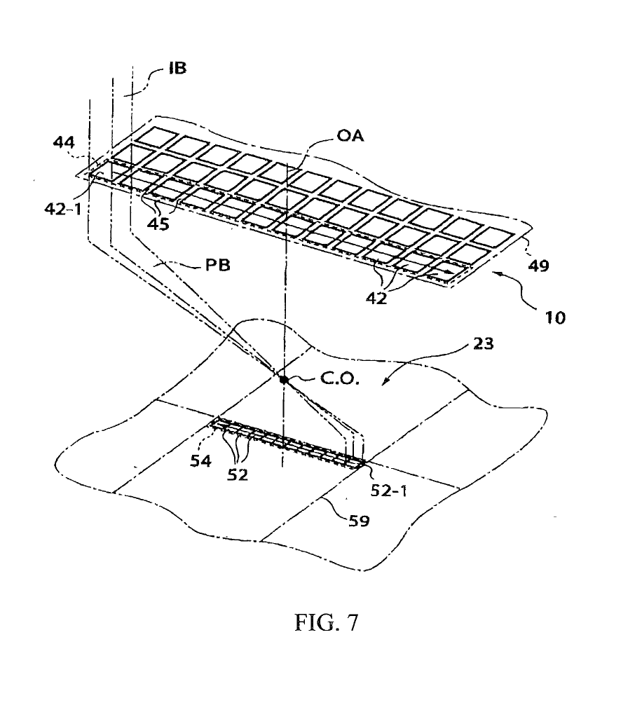

Situated downstream of the reticle 10 are first and second projection lenses 15, 19, respectively, and an imaging-position deflector 16. (A more detailed description of the operation of the projection lenses 15, 19 and deflector 16 is provided later below with reference to FIG. 7.) The illumination beam, by passage through an illuminated subfield of the reticle 10, becomes a “patterned beam” because the beam has acquired an aerial image of the illuminated subfield. The patterned beam is imaged at a specified location on a lithographic substrate 23 (e.g., “wafer”) by the projection lenses 15, 19 collectively functioning as a “projection-lens assembly.” To ensure imaging at the proper location, the imaging-position deflector 16 imparts the required lateral deflection of the patterned beam.

So as to be imprintable with the image carried by the patterned beam, the upstream-facing surface of the substrate 23 is coated with a suitable “resist” that is imprintably sensitive to exposure by the patterned beam. When forming the image on the substrate, the projection-lens assembly “reduces” (demagnifies) the aerial image. Thus, the image as formed on the substrate 23 is smaller (usually by a defined factor termed the “demagnification factor”) than the corresponding region illuminated on the reticle 10. By thus causing imprinting on the surface of the substrate 23, the apparatus of FIG. 5 achieves “transfer” of the pattern image from the reticle 10 to the substrate 23.

The components of the depicted electron-optical system situated between the reticle 10 and the substrate 23 collectively are termed the “projection-optical system.” The substrate 23 is mounted on a substrate stage 24 situated downstream of the projection-optical system. As the patterned beam propagates through the projection-optical system, the beam actually travels in a downstream direction through an axially aligned “beam tube” (not shown but well understood in the art) that can be evacuated to a desired vacuum level.

The projection-optical system forms a crossover C.O. of the patterned beam on the optical axis Ax at the back focal plane of the first projection lens 15. The position of the crossover C.O. on the optical axis Ax is a point at which the axial distance between the reticle 10 and substrate 23 is divided according to the demagnification ratio. Situated between the crossover C.O. (i.e., the rear focal plane) and the reticle 10 is a contrast-aperture diaphragm 18. The contrast-aperture diaphragm 18 comprises an aperture plate that defines an aperture centered on the axis Ax. With the contrast-aperture diaphragm 18, electrons of the patterned beam that were scattered during transmission through the reticle 10 are blocked so as not to reach the substrate 23.

A backscattered-electron (BSE) detector 22 is situated immediately upstream of the substrate 23. The BSE detector 22 is configured to detect and quantify electrons backscattered from certain marks situated on the upstream-facing surface of the substrate 23 or on an upstream-facing surface of the substrate stage 24. For example, a mark on the substrate 23 can be scanned by a beam that has passed through a corresponding mark pattern on the reticle 10. By detecting backscattered electrons from the mark at the substrate 23, it is possible to determine the relative positional relationship of the reticle 10 and the substrate 23.

The substrate 23 is mounted to the substrate stage 24 via a wafer chuck (not shown but well understood in the art), which presents the upstream-facing surface of the substrate 23 in an XY plane. The substrate stage 24 (with chuck and substrate 23) is movable in the X and Y directions. Thus, by simultaneously scanning the reticle stage 11 and the substrate stage 24 in mutually opposite directions, it is possible to transfer each subfield within the optical field of the illumination-optical system as well as each subfield outside the optical field to corresponding regions on the substrate 23. The substrate stage 24 also includes a “position detector” 25 configured similarly to the position detector 12 of the reticle stage 11.

Each of the lenses 2, 3, 9, 15, 19 and deflectors 5, 8, 16 is controlled by a controller 31 via a respective coil-power controller 2a, 3a, 9a, 15a, 19a and 5a, 8a, 16a. Similarly, the controller 31, via respective stage drivers 11 a and 24a, controls operation of the reticle stage 11 and substrate stage 24. The position detectors 12, 25 produce and route respective stage-position signals to the controller 31 via respective interfaces 12a, 25a each including amplifiers, analog-to-digital (A/D) converters, and other circuitry for achieving such ends. In addition, the BSE detector 22 produces and routes signals to the controller 31 via a respective interface 22a.

From the respective data routed to it, the controller 31 ascertains, inter alia, any control errors of the respective stage positions as a subfield is being transferred. To correct such control errors, the imaging-position deflector 16 is energized appropriately to deflect the patterned beam. Thus, a reduced image of the illuminated subfield on the reticle 10 is transferred accurately to the desired position on the substrate 23. This real-time correction is made as each respective image of a subfield is transferred to the substrate 23, and the images are positioned such that they are stitched together in a proper manner on the substrate 23.

A typical divided reticle as used for scan-and-repeat CPB microlithography is shown in FIGS. 6(A)-6(C). FIG. 6(A) is a plan view of the reticle, FIG. 6(B) is an oblique elevational view of a portion of the reticle, and FIG. 6(C) is a plan view of a single subfield of the reticle. This type of reticle can be fabricated from a divided reticle “blank” (made from a silicon wafer, for example) on which the pattern is defined by electron-beam “drawing” or other suitable technique.

The reticle 10 shown in FIG. 6(A) comprises a large number of membrane regions 41 each having a square profile. Each membrane region 41 comprises a respective patterned region (subfield) 42 and a respective non-patterned “skirt” 43 (FIG. 6(C)) extending around the periphery of the subfield. Each subfield 42 defines a respective portion of the pattern defined by the reticle 10. The skirt 43 is a region in which, during exposure of the subfield 42, the edge of the illumination beam falls. Each membrane region 41 has a thickness ranging from approximately 0.1 μm to a few μm, depending upon the type of reticle. For example, stencil-type reticles, in which pattern elements are defined as respective apertures in the membrane, tend to have a thicker membrane than continuous-membrane reticles, in which pattern elements are defined as respective regions of a scattering layer formed on a thin, continuous reticle membrane.

A single subfield 42 typically has dimensions of approximately 1 mm per side on the reticle. At a projection demagnification of ¼, the size of the corresponding subfield image formed on the substrate is approximately 0.25 mm per side. On the reticle (FIG. 6(A)) the membrane regions 41 are separated from one another by support struts 45 that extend parallel to each other in the X and Y directions in a structure termed “grillage.” Each support strut 45 has a structural-beam configuration, with a thickness (in the Z direction) of approximately 0.5 to 1 mm and a width of approximately 0.1 mm. The grillage confers substantial mechanical strength and rigidity to the reticle 10, especially to the membrane portions 41 thereof. The width of each skirt 43 is approximately 0.05 mm, for example.

As seen in FIG. 6(A), the membrane regions 41 are arrayed rectilinearly in the X and Y directions. For example, large groups of membrane regions 41 are called “stripes” (also termed “mechanical stripes”) 49 that extend longitudinally in the Y direction. Each stripe 49 comprises multiple rows (“electrical stripes”) of membrane regions 41 that extend in the X direction. The longitudinal dimension (in the X direction) of each electrical stripe 44 (equal to the width of the mechanical stripe 49) is defined by the width of the optical field of the illumination optical system, which is equal to the maximum achievable lateral deflection of the illumination beam.

The reticle 10 comprises multiple parallel mechanical stripes 49 arrayed in the X direction. Extending in the Y direction between adjacent mechanical stripes 49 is a respective wide strut 47, which confers additional strength and rigidity to the reticle 10. The wide struts 47 are integral to the grillage 45.

Typically, the reticle is exposed in a “sequential” manner, i.e., subfield-by-subfield within each electrical stripe 44, and electrical stripe-by-electrical stripe within each mechanical stripe 49, and mechanical stripe-by-mechanical stripe. The subfields 42 in an electrical stripe 44 are exposed in a continuously executed, sequential-step manner by lateral deflection of the illumination and patterned beams in the X direction. (“Electrical” stripes 44 are so-named because beam deflections for exposing successive subfields in them usually are performed electrostatically using a deflector.) Meanwhile, the electrical stripes 44 in a mechanical stripe 49 are exposed sequentially by corresponding continuous scanning movements of the reticle stage 11 and substrate stage 24 in the Y direction. (“Mechanical” stripes 49 are so-named because positioning motions required for exposing successive electrical stripes in them are achieved by respective mechanical stage motions.)

This manner of exposure is shown more clearly in FIG. 7, which depicts one end of a mechanical stripe 49 in which each electrical stripe 44 comprises twelve subfields 42 (skirts 43 are not shown) separated from each other by struts 45 of the grillage, as described above. Downstream of the reticle 10 is a lithographic substrate 23 facing the reticle 10. In the figure a first subfield 42-1 in the left corner of the first electrical stripe 44 of the mechanical stripe 49 on the reticle 10 is illuminated from upstream by an illumination beam 13. Passage of the illumination beam IB through the subfield 42-1 forms a patterned beam PB. The patterned beam is demagnified and projected by the two-stage projection-lens assembly and imaging-position deflector (not shown, but see lenses 15, 19 and deflector 16 in FIG. 5) onto a predetermined region 52-1 on the substrate 23. The patterned beam PB is deflected twice between the reticle 10 and the substrate 23 by operation of the two-stage projection-lens assembly. The first deflection is from a direction parallel to the optical axis OA to a direction that intersects the optical axis OA, and the second deflection is the reverse of the first deflection.

The respective transfer positions of the subfield images on the substrate 23 are adjusted as required by the imaging-position deflector 16 in the projection-optical system so that the transferred subfield images are contiguous with each other. That is, the patterned beam PB, formed by passage of the illumination beam IB through a particular subfield 42 on the reticle, is converged on the substrate 23 by the first and second projection lenses 15, 19 (FIG. 5). The images are formed such that no images of grillage or skirts are formed between the subfield images.

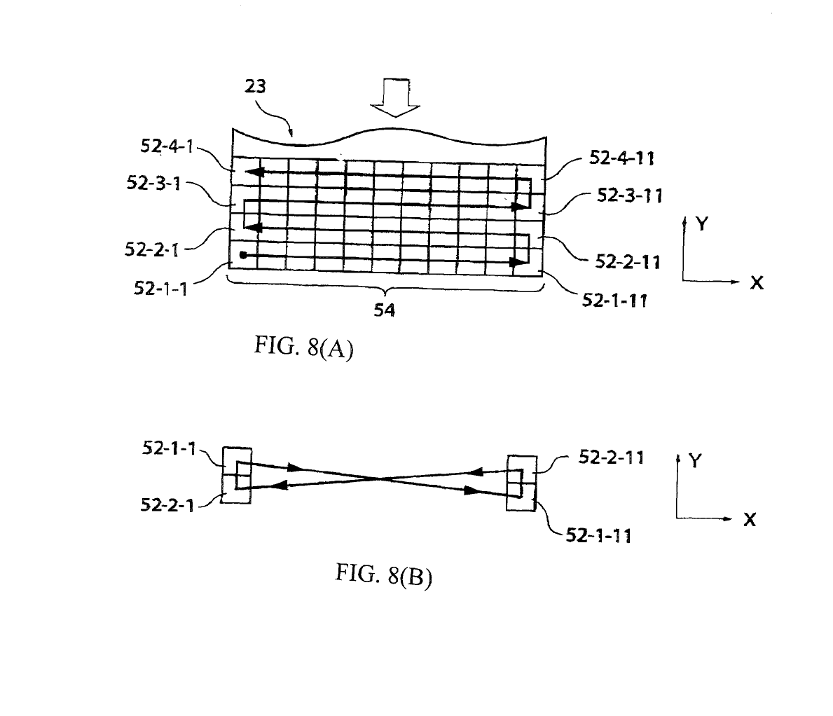

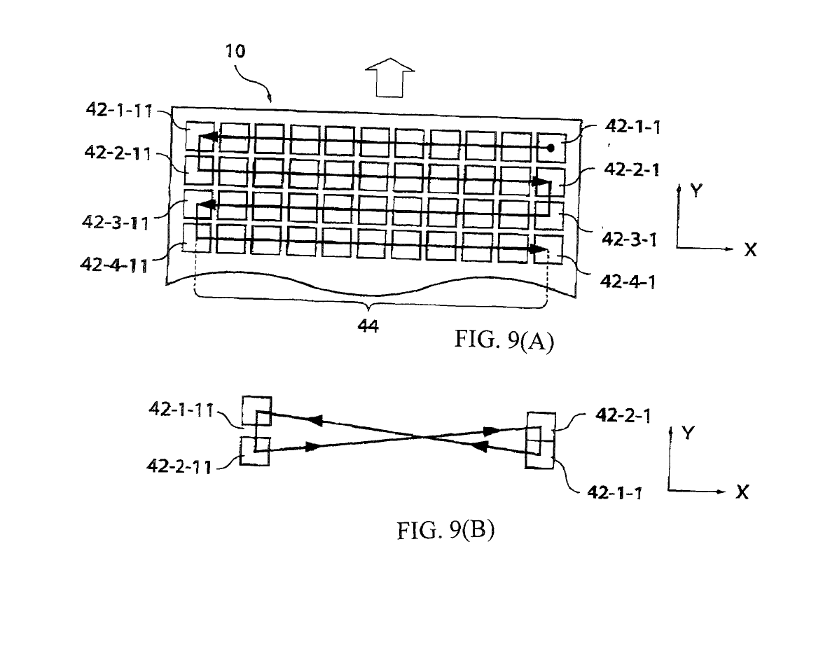

The manner of making an exposure is shown in FIGS. 8(A)-8(B) and 9(A)9(B). FIG. 8(A) depicts an exemplary subfield-exposure sequence as viewed from a system fixed to the substrate 23, and FIG. 8(B) shows the “deflection-path cycle” (i.e., the cyclical profile, as viewed from a system fixed to the optical axis or other stationary location, of deflection of the patterned beam to make the successive subfield exposures in multiple electrical stripes). Similarly, FIG. 9(A) depicts an exemplary subfield-exposure sequence as viewed from upstream of the reticle 10, and FIG. 9(B) shows the deflection-path cycle of the illumination beam as it makes the successive subfield exposures in multiple electrical stripes.

Turning first to FIG. 8(A), a portion of the substrate 23 is shown as carried on the substrate stage 24. The depicted portion is part of a mechanical stripe in which four electrical stripes 54 are shown. The electrical stripes 54 are arrayed in the Y direction. Each electrical stripe comprises eleven subfields 52 arranged in a row extending longitudinally in the X direction. As indicated by the arrows in the figure, as the substrate stage 24 is moved continuously in the −Y direction (large, thick vertical arrow), the patterned beam is scanned (thinner, horizontal arrow) left-to-right in the +X direction from subfield 52-1-1 to subfield 52-1-11 in the first electrical stripe 54. Meanwhile, the substrate stage 24 moves the substrate 23 continuously downward in the figure. To ensure proper placement of the subfield images on the substrate surface, the actual deflection path of the patterned beam produced by scanning the illumination beam along successive electrical stripes has a profile as shown in FIG. 8(B). For example, as the beam is being deflected in the +X direction to scan the first electrical stripe (subfields 52-1-1 to 52-1-11), the beam also is being deflected in the −Y direction to follow the motion of the substrate 23. As a result, the deflection path actually is sloped relative to horizontal in the figure, which requires coordinated deflections of the beam in both the X and Y directions. The requisite Y-direction deflection is achieved using a deflector in the projection-optical system. Lateral deflection of the beam in the X direction (i.e., the main deflection of the beam) is achieved by operation of the projection lenses and deflectors in the projection-optical system, as explained above with reference to FIG. 7.

After exposing the last subfield 52-1-11 in the first electrical stripe, the patterned beam is deflected in the +Y direction to expose the subfield 52-2-11 at the “right” end of the next electrical stripe, and is deflected laterally in the −X direction to expose the subfields in that electrical stripe. Thus, exposure proceeds to the subfield 52-2-1 at the “left” end of the second electrical stripe. During exposure of the second electrical stripe, the actual deflection path of the patterned beam is sloped relative to horizontal in the figure. In this manner, all the subfields in the second electrical stripe are exposed by coordinated deflections of the beam in both the X and Y directions.

Turning now to FIG. 9(A), a portion of the reticle 10 is shown as carried on the reticle stage 11. The depicted portion is part of a mechanical stripe in which four electrical stripes 44 are shown. The electrical stripes 44 are arrayed in the Y direction. Each electrical stripe 44 comprises eleven subfields 42 arranged in a row extending longitudinally in the X direction. As indicated by the arrows in the figure, as the reticle stage 11 is being moved continuously in the +Y direction (large, thick vertical arrow), the illumination beam is being scanned (thinner, horizontal arrow) right-to-left in the −X direction from subfield 42-1-1 to subfield 42-1-11 in the first electrical stripe 44. Meanwhile, the reticle stage 11 is moving the reticle 10 continuously upward in the figure. To ensure proper placement of the subfield images on the substrate surface, the actual deflection path of the illumination beam has a profile as shown in FIG. 9(B). For example, as the beam is being deflected in the −X direction to scan the first electrical stripe (subfields 42-1-1 to 42-1-11), the beam also is being deflected in the +Y direction to follow the motion of the reticle 10. As a result, the deflection path actually is sloped relative to horizontal in the figure, which requires coordinated deflections of the beam in both the X and Y directions. The requisite Y-direction deflection is achieved using a deflector in the illumination-optical system. Lateral deflection of the beam in the X direction (i.e., the main deflection of the beam) is achieved by operation of the lenses and deflectors in the illumination-optical system, as explained above with reference to FIG. 7.

After exposing the last subfield 42-1-11 in the first electrical stripe, the illumination beam is deflected in the −Y direction to expose the subfield 42-2-11 at the “left” end of the next electrical stripe, and is deflected laterally in the +X direction to expose the subfields in that electrical stripe. Thus, exposure proceeds to the subfield 42-2-1 at the “right” end of the second electrical stripe. During exposure of the second electrical stripe, the actual deflection path of the illumination beam is sloped relative to horizontal in the figure. In this manner, all the subfields in the second electrical stripe are exposed by coordinated deflections of the beam in both the X and Y directions.

As understood from the foregoing, the patterned beam and illumination beam shown in FIGS. 8(B) and 9(B), respectively, have respective deflection-path profiles (viewed from a location on the optical axis or other stationary location) that, as deflection proceeds in a repetitive cyclic manner from one electrical stripe to the next, assumes a figure-8 profile. In this example the number of exposure positions within each lateral (X direction) sweep of the beam is eleven (corresponding with eleven subfields per electrical stripe). Hence, a total of twenty-two exposure positions are defined in each of the deflection profiles shown in FIGS. 8(B) and 9(B). A calibration desirably is performed at each of these exposure positions.

To perform calibrations for a particular segmented reticle, a “calibration target” is provided in the form of subfields at the reticle plane (i.e., on the reticle or reticle stage), and a corresponding calibration target is provided at the substrate plane (i.e., on the substrate or substrate stage). The calibration target is configured to have the same number of subfields (deflection positions) per electrical stripe as the actual lithographic pattern as defined on the reticle. The calibration target is configured so as to allow all the deflection positions in each lateral scan direction to be calibrated continuously in a single respective sweep of the beam.

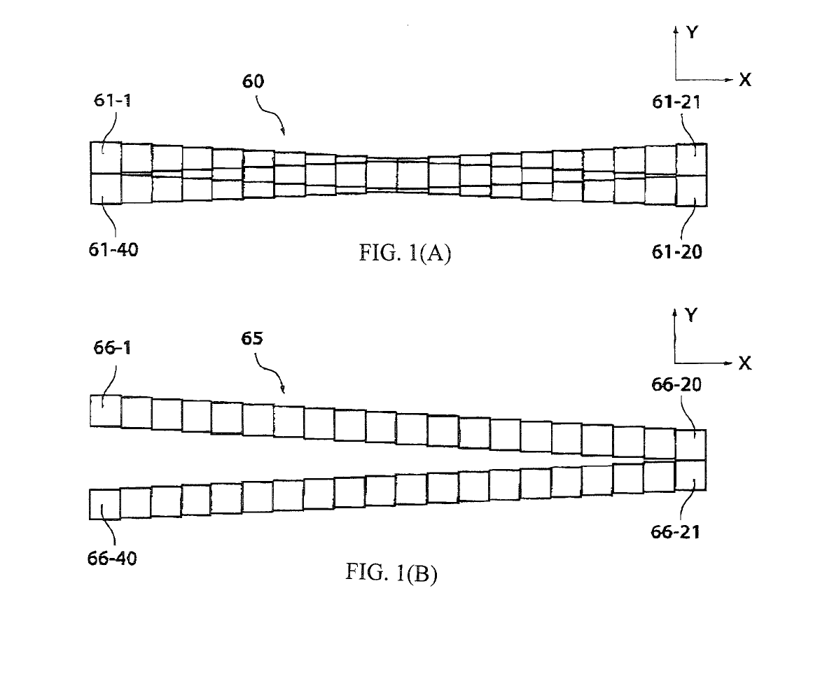

A calibration target according to a first representative embodiment is described with reference to FIGS. 1(A)-1(B). The subject calibration target is applicable to reticle patterns in which each electrical stripe contains, by way of example, twenty respective subfields. FIG. 1(A) shows the full deflection-path cycle 60 (as viewed from a system fixed to the optical axis or other stationary location) of the beam for making an exposure at each deflection position required for exposure of the reticle pattern. FIG. 1(B) shows the corresponding arrangement 65 of calibration subfields on the reticle and substrate planes, wherein each calibration subfield includes respective calibration mark(s). Since each electrical stripe contains twenty subfields, twenty exposures are made per scan of the respective electrical stripe, each exposure being made at a respective deflection position. Referring to FIG. 1(A), beam deflection proceeds in the +X direction from an upper left deflection position 61-1 to a lower right deflection position 61-20. Beam deflection then is “upward” (in the +Y direction) in the figure to reach the deflection position 61-21 in the next electrical stripe. Beam deflection then proceeds in the −X direction through the deflection positions of the second electrical stripe to the lower left deflection position 61-40. To begin exposure of the third electrical stripe, the beam is deflected “upward” (in the +Y direction) to return to the deflection position 61-1, thereby completing one deflection-path cycle. On the substrate, if the size of an exposed subfield image is 0.25-mm square, then the deflection “width” (in the X direction) of the deflection configuration 60 is 5 mm.

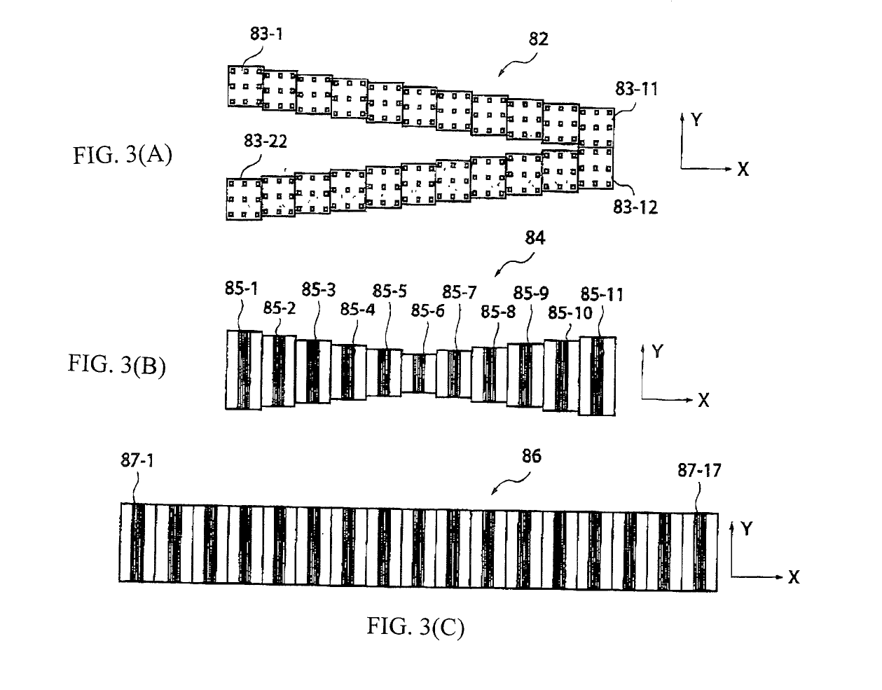

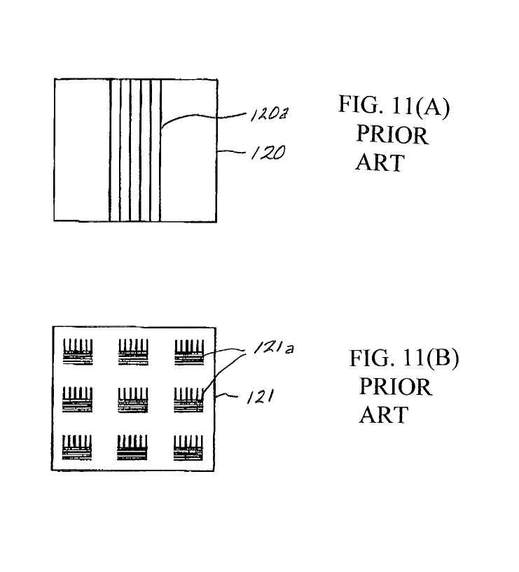

FIG. 1(B) shows a group 65 of subfields, containing respective calibration mark(s), as formed on the reticle plane (reticle stage 11 or reticle 10) and on the substrate plane (substrate stage 24 or substrate 23). The subfield group 65 corresponds to the deflection-path cycle 60 of FIG. 1(A), but is configured such that no subfield overlaps another subfield. The subfield group 65 comprises a total of forty subfields 66-1 to 66-20 and 66-21 to 66-40, wherein the array of subfields 66-1 to 66-20 is parallel to the array of deflection positions 61-1 to 61-20 in FIG. 1(A), and the array of subfields 66-21 to 66-40 is parallel to the array of deflection positions 61-21 to 61-40. Each of these subfields 66-1 to 66-40 includes a mark or marks such as shown in FIG. 11 or FIGS. 3(A)-3(C).

To perform a calibration, first, the reticle stage and wafer stage are moved so that the respective deflection centers (normally the optical axis) of the illumination-optical system and projection-optical system, respectively, is situated in the center of the subfield group 65. Next, while keeping the reticle stage and substrate stage stationary, the beams are scanned in the X direction and deflected in the Y direction as required to scan the subfields 66-1 to 66-20 in a continuously executed, sequential-step (subfield-by-subfield) manner, and the beam characteristics are measured at each of these subfields. Next, the reticle stage and wafer stage are moved as required so that the respective deflection centers of the illumination-optical system and projection-optical system, respectively, are again situated in the center of the subfield group 65. Next, while keeping the reticle stage and substrate stage stationary, the beams are scanned in the X direction and deflected in the Y direction as required to scan the subfields 66-21 to 66-40 in a continuously executed, sequential-step manner, and the beam characteristics (e.g., magnification, rotation, distortion) are measured at each of these subfields. When measuring the beam characteristics at a particular subfield 66, the beam performs a tiny scan of the respective mark(s) in the subfield on the reticle plane over the respective mark(s) in the subfield in the substrate plane. Based on the respective measurements of beam characteristics, a respective optical-system-calibration coefficient is established for the respective subfield 66. Thus, the illumination-optical system and projection-optical system are “calibrated” for each subfield (deflection position) that the illumination beam and patterned beam can assume for exposing the entire reticle. During an actual exposure, at each subfield positioned at a respective location is being exposed, the CPB optical system (illumination-optical system and projection-optical system) is adjusted as required to correct, e.g., deflection-position error, image-magnification error, and image-rotation error according to the respective calibration coefficient.

To determine the calibration coefficients and to make the respective corrections for each of the forty deflection positions of this example, only two movements of the stages 11, 24 are required, in contrast to forty stage movements (one for each of the same number of deflection positions) that would be required in conventional methods. As a result, calibration time is reduced greatly. Also, even though the calibrations are performed in advance of commencing actual exposure, it nevertheless is possible to obtain the same calibration accuracy as obtained in the conventional method in which the stages are moved and positioned separately for calibrating each deflection position.

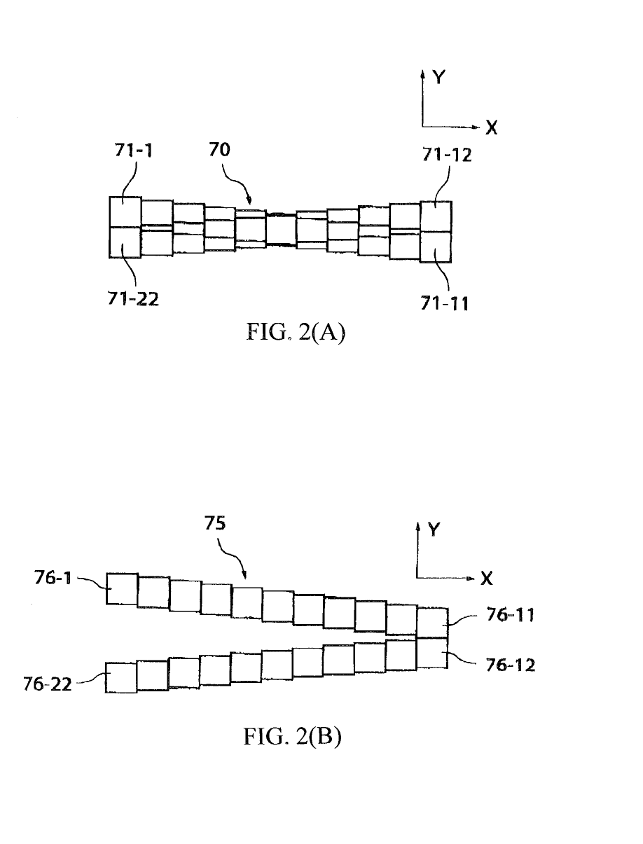

A calibration target according to a second representative embodiment is described with reference to FIGS. 2(A)-2(B). The subject calibration target is applicable to reticle patterns in which each electrical stripe contains, by way of example, eleven respective subfields. FIG. 2(A) shows the full deflection-path cycle of the beam for making an exposure at each deflection position required for exposing the reticle pattern. FIG. 2(B) shows the arrangement 75 of subfields on the reticle and substrate planes, wherein each subfield includes respective calibration mark(s). In this embodiment, the deflection width is narrower than in the embodiment of FIGS. 1(A)-1(B). Specifically, in FIG. 2(A) the number of deflection positions per sweep in the deflection-path cycle 70 is eleven, corresponding to eleven respective exposures per lateral scan of the respective electrical stripe. In the deflection-path cycle 70 the array of deflection positions 71-1 to 71-11 is sloped “downward” (in the −Y direction) and to the right (in the +X direction), and the array of deflection positions 71-12 to 71-22 is sloped “downward” (in the −Y direction)) and to the left (in the −X direction). As in the first representative embodiment, after the beam has been deflected fully in the X direction (thereby completing one electrical stripe), the beam is deflected exactly one subfield in the Y direction to proceed to the next electrical stripe. Since the number of deflection positions is less in this second embodiment than in the first embodiment, the change in the Y-direction position of the beam required per shift of deflection position is greater than in the first embodiment.

FIG. 2(B) shows a group 75 of subfields, containing respective calibration mark(s) as formed on the reticle plane and substrate plane. The subfield group 75 corresponds to the deflection-path cycle 70 of FIG. 2(A), but is configured such that no subfield overlaps another subfield. The subfield group 75 comprises a total of twenty-two subfields: subfields 76-1 to 76-11 arrayed parallel to the array of deflection positions 71-1 to 71-11 in FIG. 2(A), and subfields 76-12 to 76-22 arrayed parallel to the deflection positions 71-12 to 71-22 in FIG. 2(A). The subfield 76-12 is situated adjacent to and “below” the subfield 76-11 in the figure.

In general, changing the deflection width according to the exposure pattern is often advantageous for achieving optimal throughput and pattern-transfer accuracy for each particular pattern as defined on a reticle. In any event, the CPB optical system (illumination-optical system and projection-optical system) desirably is calibrated at each deflection position along the deflection-path cycle of the beam required for exposing the reticle pattern. By configuring the calibration target as described generally in the foregoing embodiments, beam calibration can be performed while continuously scanning the beam in a stepwise manner from one calibration subfield to the next.

Respective examples of calibration marks are shown in FIGS. 3(A)-3(B). FIG. 3(A) depicts an exemplary mark pattern for measuring image rotation, magnification, distortion, etc., of subfields arranged in electrical stripes each containing eleven respective subfields. FIG. 3(B) depicts an exemplary mark pattern for measuring deflection position of the subfields arranged in electrical stripes each containing eleven respective subfields. FIG. 3(C) depicts an exemplary mark pattern in which each X-direction subfield (in an electrical stripe containing seventeen subfields) is identical in size.

Turning first to FIG. 3(A), the depicted subfield group 82 corresponds to the calibration target shown in FIG. 2(B) and the deflection-path cycle shown in FIG. 2(A). The subfield group 82 comprises a total of twenty-two mark-containing subfields 83, including subfields 83-1 to 83-11 arrayed parallel to the array of deflection positions 71-1 to 71-11 in FIG. 2(A), and subfields 83-12 to 83-22 arrayed parallel to the array of deflection positions 71-12 to 71-22 in FIG. 2(A). The subfield 83-12 is situated adjacent to and “below” the subfield 83-11 in the figure. In each subfield, the respective marks are defined as L/S patterns (extending in both the X and Y directions) such as shown in FIG. 11(B). A respective L/S pattern is situated at each of nine locations in each subfield 83 (each L/S pattern is indicated as a respective square in FIG. 3(A)). The subfield group 82 is defined on the reticle plane and on the substrate plane. As the respective L/S patterns in each subfield are being scanned by the beam, rotation, magnification, distortion, etc., of the beam are being measured accurately within each respective subfield.

FIG. 3(B) shows a subfield group 84 corresponding to the deflection-path cycle shown in FIG. 2(A). The subfield group 84 includes eleven subfields 85-1 to 85-11 arrayed in the X direction. The center subfield 85-6 is square, but the Y-direction lengths of the subfields situated away from the center subfield are increasingly elongated “vertically” with increased distance from the center subfield. Thus, the subfields 85-1 and 85-11 at respective ends are about twice as long as the center subfield 85-6. A respective L/S pattern extending longitudinally in the Y direction (see FIG. 11(A)) is disposed in the center of each subfield 85. The subfield group 84 is defined on the reticle plane and on the substrate plane. As the respective L/S pattern in each subfield is being scanned by the beam, the respective deflection position of the beam is measured accurately within each subfield. The mark scheme shown in FIG. 3(B) allows the size of individual marks to be reduced.

FIG. 3(C) shows a subfield group 86, in which all of the subfields in the X direction have the same dimensions. The subfield group 86 includes seventeen subfields 87-1 to 87-17 arrayed in the X direction. The X-direction width of each subfield 87 is equal to the width of the respective subfield of the lithographic pattern, and the Y-direction length of each subfield 87 is approximately twice the length of the respective subfield of the lithographic pattern. A respective L/S pattern extending longitudinally in the Y direction (see FIG. 11(A)) is disposed in the center of each subfield 87. The subfield group 86 is defined on the reticle plane and on the substrate plane. As the beam scans the respective L/S patterns in each subfield, the deflection position of the beam is measured accurately within each respective subfield.

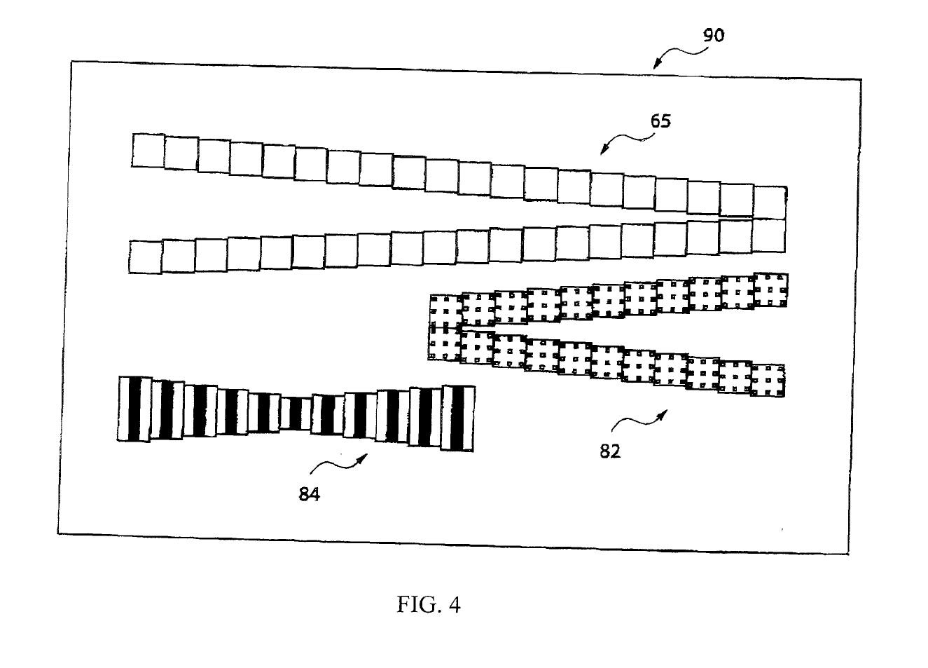

FIG. 4 depicts the subfield group 65 (see FIG. 1(B)), the subfield group 82 (see FIG. 3(A)), and the subfield group 84 (see FIG. 3(B)) disposed on a single mark plate 90. By placing the mark plate 90 on the reticle stage 11 (i.e., on the reticle plane) and on the substrate stage 24 (i.e., on the substrate plane), beam calibrations can be performed using any of various types of deflection-path cycles without having to replace the mark plate each time the reticle defining the lithographic pattern is changed.

The embodiments described above achieve substantial reduction in time utilized for calibrating a CPB optical system in a CPB microlithography system, thereby substantially reducing maintenance time needed for system operation. As a result, a substantial reduction in device-operation time is realized, compared to conventional systems.

Whereas the invention has been described above in connection with multiple representative embodiments, the invention is not limited to those embodiments. On the contrary, the invention is intended to encompass all modifications, alternatives, and equivalents as may be included within the spirit and scope of the invention, as defined by the appended claims.

What is claimed is:

1. In a charged-particle-beam (CPB) microlithography method in which a pattern, defined on a reticle segmented into multiple pattern subfields and situated on a reticle stage at a reticle plane, is illuminated subfield-by-subfield by a charged-particle illumination beam passing through an illumination-optical system and forming a patterned beam that passes through a projection-optical system to a lithographic substrate situated on a substrate stage at a substrate plane, the projection-optical system forming respective pattern-subfield images on the substrate in respective locations at which the images are stitched together to form a transferred pattern, the pattern subfields being arranged on the reticle in a rectilinear array extending in X and Y directions and forming at least one mechanical stripe comprising multiple electrical stripes each consisting of a row of multiple respective pattern subfields, and while moving the stages at respectice scan velocities in the Y direction, the illumination and patterned beams are defectively scanned in the X direction so as to transfer, in a sequential and continuous manner, respective images of the pattern subfields at the reticle plane on each subfield at the substrate plane, a method for calibrating the illumination-optical system and projection-optical systems, comprising:
on each of the reticle plane and substrate plane, providing a respective calibration target each comprising multiple mark-containing calibration subfields arranged in an array corresponding to respective deflection positions of a respective deflection-path cycle assumed by the illumination and patterned beams during sequential exposure of the pattern subfields in multiple electrical stripes;
while keeping the stages stationary, scanning the illumination and patterned beams in the X direction while deflecting the illumination and patterned beams in the Y direction so as to scan, in a continuously executed, sequential-step manner, an image of the respective calibration subfield at the reticle plane over each respective calibration subfield at the substrate plane;
as each calibration subfield at the substrate plane is being scanned, detecting backscattered charged particles produced by impingement of the image of the respective calibration subfield at the reticle plane so as to obtain data regarding beam characteristics at each calibration subfield; and
from the beam-characteristics data obtained for each calibration subfield, determining respective CPB-optical-system correction coefficients for each deflection position represented by a respective calibration subfield.

2. The method of claim 1, wherein the respective calibration subfields situated at the reticle plane and substrate plane are situated on the reticle and lithographic substrate, respectively.

3. The method of claim 1, wherein the respective calibration subfields situated at the reticle plane and substrate plane are situated on the reticle stage and substrate stage, respectively.

4. The method of claim 1, wherein:
the respective calibration subfields situated at the reticle plane are situated on the reticle or reticle stage; and
the respective calibration subfields situated at the substrate plane are situated on the substrate or substrate stage.

5. The method of claim 1, further comprising the step of adjusting, for each pattern subfield corresponding to a respective deflection position of the calibration target, at least one of the illumination-optical system and projection-optical system based on the respective CPB-optical-system correction coefficient for the deflection position.

6. The method of claim 1, wherein:
the step of providing respective calibration targets comprises providing multiple calibration targets at each of the reticle plane and substrate plane;
each calibration target comprises a respective array of multiple calibration subfields; and
each array corresponds to a respective different deflection-path cycle.

7. The method of claim 1, wherein:
the step of providing respective calibration targets comprises providing multiple calibration targets at each of the reticle plane and substrate plane;
each calibration target comprises a respective array of multiple calibration subfields; and
each array corresponds to a respective different beam characteristic.

8. The method of claim 1, wherein each calibration subfield comprises at least one calibration mark configured for determining at least one of image rotation, image magnification, and image distortion in the respective deflection position.

9. The method of claim 1, wherein each calibration subfield comprises at least one calibration mark configured for determining beam position in the respective deflection position.

10. A method for performing charged-particle-beam (CPB) microlithography of a pattern, defined on a reticle segmented into multiple pattern subfields arranged in a rectilinear array extending in the X and Y directions and forming at least one mechanical stripe comprising multiple electrical stripes each consisting of a row of multiple respective pattern subfields, to a lithographic substrate, the method comprising:
mounting the reticle on a reticle stage situated at a reticle plane;
mounting the lithographic substrate on a substrate stage situated at a substrate plane;
illuminating the pattern subfields in a continuously executed, sequential-step manner with an illumination beam passing through an illumination-optical system, thereby forming a patterned beam;
from each illuminated pattern subfield, directing the patterned beam through a projection-optical system to form a respective subfield image on the substrate in a respective location such that the pattern-subfield images are stitched together to form a transferred pattern;
on each of the reticle plane and substrate plane, providing a respective calibration target each comprising multiple mark-containing calibration subfields arranged in an array in which respective positions of the calibration subfields correspond to respective deflection positions of a deflection-path cycle assumed by the illumination and patterned beams during sequential exposure of the pattern subfields in multiple electrical stripes;
while keeping the stages stationary, defectively scanning the illumination and patterned beams in the X direction so as to scan, in a continuously executed, sequential-step manner, an image of the respective calibration subfield at the reticle plane over each respective calibration subfield at the substrate plane;
as each calibration subfield at the substrate plane is being scanned, detecting backscattered charged particles produced by impingement of the image of the respective calibration subfield at the reticle plane so as to obtain data regarding beam characteristics at each calibration subfield;
from the beam-characteristics data obtained for each calibration subfield, determining respective CPB-optical-system correction coefficients for each deflection position represented by a respective calibration subfield; and
as each patterned subfield is being exposed, correcting the beam according to the respective correction coefficient for the respective deflection position of the patterned subfield being exposed.

11. A charged-particle-beam (CPB) system for transferring a pattern, defined on a reticle segmented into multiple pattern subfields each defining a respective portion of the pattern, to a lithographic substrate on which respective images of the pattern subfields are formed so as to be stitched together in a contiguous manner, the pattern subfields being arranged on the reticle in a rectilinear array extending in X and Y directions and forming at least one mechanical stripe comprising multiple electrical stripes each consisting of a row of multiple respective pattern subfields, the system comprising:
a reticle stage to which the reticle is mounted at a reticle plane;
an illumination-optical system situated upstream of the reticle stage and configured (1) to direct a charged-particle illumination beam from a source to individual pattern subfields of the reticle, and (2) to cause the illumination beam to be scanned in the X direction and deflected in the Y direction so as to illuminate the pattern subfields in a continuously executed, sequential-step manner;
a substrate stage to which the substrate is mounted at a substrate plane;
a projection-optical system situated between the reticle stage and substrate stage and configured (1) to direct a charged-particle patterned beam, produced by passage of the illumination beam through an illuminated pattern subfield, from the reticle to a corresponding selected location on the substrate, and (2) to cause the patterned beam to project respective images of the illuminated pattern sub fields to the substrate in a sequential manner; and
a first beam-calibration target situated at the reticle plane and a corresponding second beam-calibration target situated at the substrate plane, each beam-calibration target comprising multiple calibration subfields arranged in an array corresponding to respective deflection positions of a deflection-path cycle assumed by the illumination and patterned beams during exposure of the pattern subfields in multiple electrical stripes.

12. The system of claim 11, wherein the calibration subfields situated in the first beam-calibration target and the calibration subfields situated in the second beam-calibration target are situated on the reticle and lithographic substrate, respectively.

13. The system of claim 11, wherein the calibration subfields situated in the first beam-calibration target and the calibration subfields situated in the second beam-calibration target are situated on the reticle stage and substrate stage, respectively.

14. The system of claim 11, wherein:
the respective calibration subfields situated at the reticle plane are situated on the reticle or reticle stage; and
the respective calibration subfields situated at the substrate plane are situated on the substrate or substrate stage.

15. The system of claim 11, further comprising a backscattered-particle detector situated and configured to detect charged particles produced by a calibration subfield in the second beam-calibration target whenever the calibration subfield is being scanned with an image of a corresponding calibration subfield in the first beam-calibration target.

16. The system of claim 15, further comprising a controller, connected to the backscattered-particle detector and to each of the illumination-optical system and projection-optical system, the controller being configured to determine a respective beam characteristic as measured at each calibration subfield of the second calibration target.

17. The system of claim 16, wherein the controller further is configured to determine, for each beam characteristic, a respective correction coefficient.

18. The system of claim 17, wherein the controller further is configured to adjust, for each pattern subfield at a respective deflection position, at least one of the illumination-optical system and projection-optical system as required based on the respective correction coefficient for the deflection position.

19. The system of claim 16, wherein at least one of the illumination-optical system and projection-optical system comprises means for adjusting, for each pattern subfield at a respective deflection position, the illumination-optical system and the projection-optical system, respectively, as required based on the respective correction coefficient for the deflection position.

20. The system of claim 11, wherein:
the reticle plane includes multiple first beam-calibration targets;
the substrate plane includes multiple second beam-calibration targets; and
each beam-calibration target comprises a respective array of multiple calibration subfields each corresponding to a respective different deflection-path cycle.

21. The system of claim 11, wherein:
the reticle plane includes multiple first beam-calibration targets;
the substrate plane includes multiple second beam-calibration targets; and
each beam-calibration target comprises a respective array of multiple calibration subfields each corresponding to a respective different beam characteristic.

22. The system of claim 21, wherein:
the first beam-calibration targets are defined on a first mark plate situated at the reticle plane; and
the second beam-calibration targets are defined on a second mark plate situated at the substrate plane.

23. The system of claim 22, wherein:
the first mark plate is mounted to the reticle stage; and
the second mark plate is mounted to the substrate stage.

24. The system of claim 11, wherein each calibration subfield comprises at least one calibration mark configured for determining at least one of image rotation, image magnification, and image distortion in the respective deflection position.

25. The system of claim 11, wherein each calibration subfield comprises at least one calibration mark configured for determining beam position in the respective deflection position.
